(19) United States
(12) Patent Application Publication
(10) Pub. No.: US 2022/0416321 A1
(43) Pub. Date: Dec. 29, 2022

(54) THERMAL RUNAWAY PROTECTION SYSTEM

(71) Applicant: Stacker L.L.C., Golden Valley, MN (US)

(72) Inventor: Norston L. Fontaine, Golden Valley, MN (US)

(73) Assignee: Stacker L.L.C., Golden Valley, MN (US)

(21) Appl. No.: 17/808,952

(22) Filed: Jun. 24, 2022

Related U.S. Application Data
(60) Provisional application No. 63/202,813, filed on Jun. 25, 2021.

(51) Int. Cl. H01M 10/48; B29C 64/393; B29C 64/295; B33Y 50/02

(52) U.S. Cl. CPC H01M 10/486; B29C 64/393; B29C 64/295; B33Y 50/02; B29C 64/118

(57) ABSTRACT

Apparatus and associated methods relate to a thermal runaway protection circuit (TRPC). In an illustrative example, the TRPC may include a state controller, a temperature sensor input to the state controller, a power output operated by the state controller to selectively provide power to a heater element, and at least one visual indicating element operated by the state controller. The state controller, for example, may activate the power output and a first predetermined indication of the at least one visual indicating element in response to the temperature input being less than a first predetermined temperature threshold. When the power output is activated, the state controller, for example, may disable the power output and deactivate the first predetermined indication, in response to the temperature sensor input rising above the first predetermined temperature threshold. Various embodiments may advantageously interlock the power to the heating element based on the temperature sensor.

### CROSS-REFERENCE TO RELATED APPLICATIONS

This application claims the benefit of U.S. Provisional Application Ser. No. 63/202,813, titled “THERMAL RUNAWAY PROTECTION SYSTEM,” filed by Norston L. Fontaine, on Jun. 25, 2021.

This application incorporates the entire contents of the foregoing application(s) herein by reference.

### TECHNICAL FIELD

Various embodiments relate generally to protection to thermal runaway protection systems.

### BACKGROUND

Additive manufacturing is a computerized process of constructing a three-dimensional object from a CAD model or a digital 3D model using an additive manufacturing machine. For example, during an additive manufacturing process, materials are deposited, joined, or solidified under computer control. In some examples, the materials (e.g., plastics, liquids or powder grains being fused) are added together layer by layer. A common additive manufacturing process may be Fused deposition modeling (FDM). FDM, for example, may use a continuous filament of a thermoplastic material to construct the 3D model.

In some examples, the filaments used may be passed through a heated chamber (e.g., sometimes called a hot end), where the filaments are transformed from a solid state to a fluid state. In one example, the filament may be heated up to 350 Fahrenheit in the hot end before being liquified and being molded into the required shape during the printing process.

### SUMMARY

Apparatus and associated methods relate to a thermal runaway protection circuit (TRPC). In an illustrative example, the TRPC may include a state controller, a temperature sensor input to the state controller, a power output operated by the state controller to selectively provide power to a heater element, and at least one visual indicating element operated by the state controller. The state controller, for example, may activate the power output and a first predetermined indication of the at least one visual indicating element in response to the temperature input being less than a first predetermined temperature threshold. When the power output is activated, the state controller, for example, may disable the power output and deactivate the first predetermined indication, in response to the temperature sensor input rising above the first predetermined temperature threshold. Various embodiments may advantageously interlock the power to the heating element based on the temperature sensor.

Various embodiments may achieve one or more advantages. For example, some embodiments may advantageously protect the heating element from early activation by preventing re-activation of the power output until a reset command is received. Some embodiments may, for example, include a power converter coupled to provide independent power input to advantageously maintain power to the TRPC when the power output is deactivated. For example, some embodiments may include threshold controls to advantageously provide user-settable first predetermined temperature threshold and/or second predetermined temperature. Some embodiments, for example, may include a logic gate configured to generate the temperature input as a function of the inputs from the first temperature sensor and the second temperature sensor to advantageously avoid erroneous deactivation of the heating element. Some embodiments, for example, may be integrated into an additive manufacturing control system to advantageously provide an easy installation of the TRPC.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary thermal runaway interlock (TRI) employed in an illustrative use-case scenario.

FIG. 2 depicts an exemplary schematic of a TRI.

FIG. 3 is an exemplary state diagram of the exemplary TRI of FIG. 2.

FIG. 4 depicts an exemplary block diagram of a digitally implemented TRI.

FIG. 5 depicts a flowchart of an exemplary method of operation of a TRI.

FIG. 6 depicts an exemplary temperature sensor of a TRI mounted to a hot end.

FIG. 7 depicts an exemplary block diagram of a digitally implemented TRI that receives input from a temperature sensor of the TRI and a built-in temperature sensor.

Like reference symbols in the various drawings indicate like elements.

### DETAILED DESCRIPTION OF ILLUSTRATIVE EMBODIMENTS

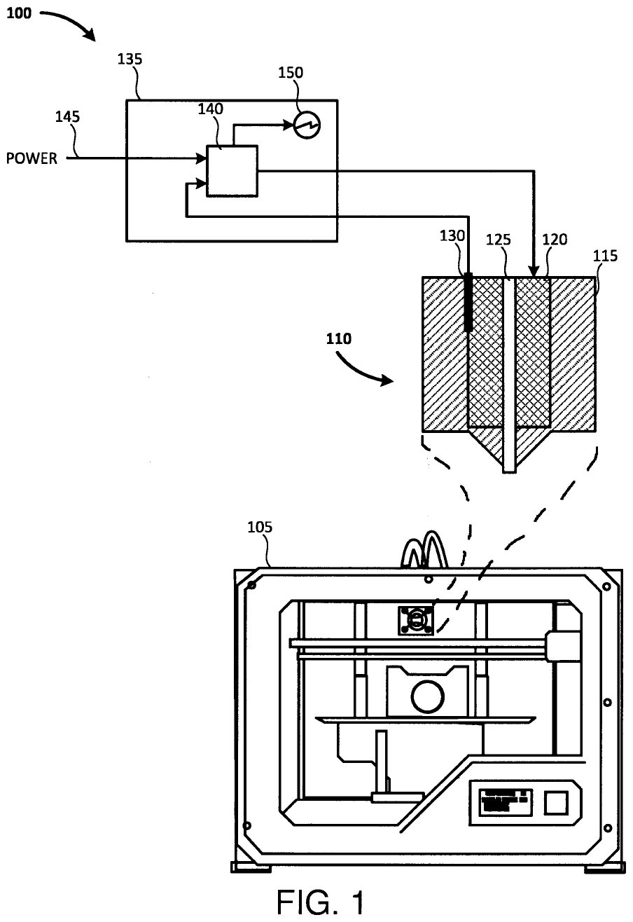

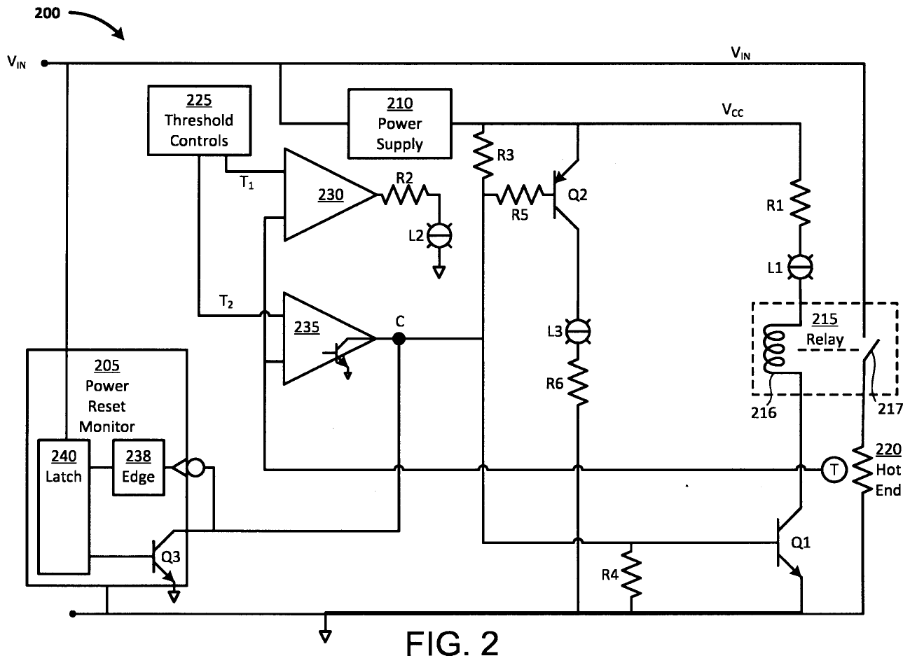

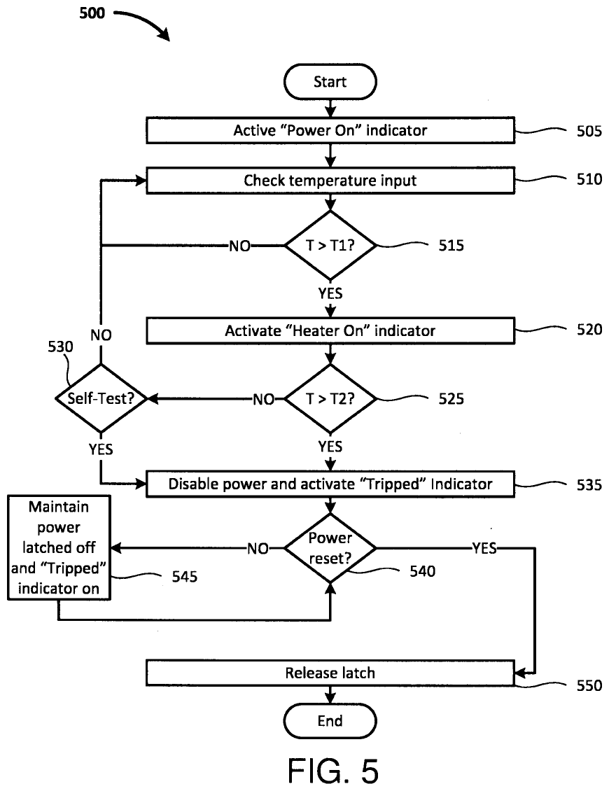

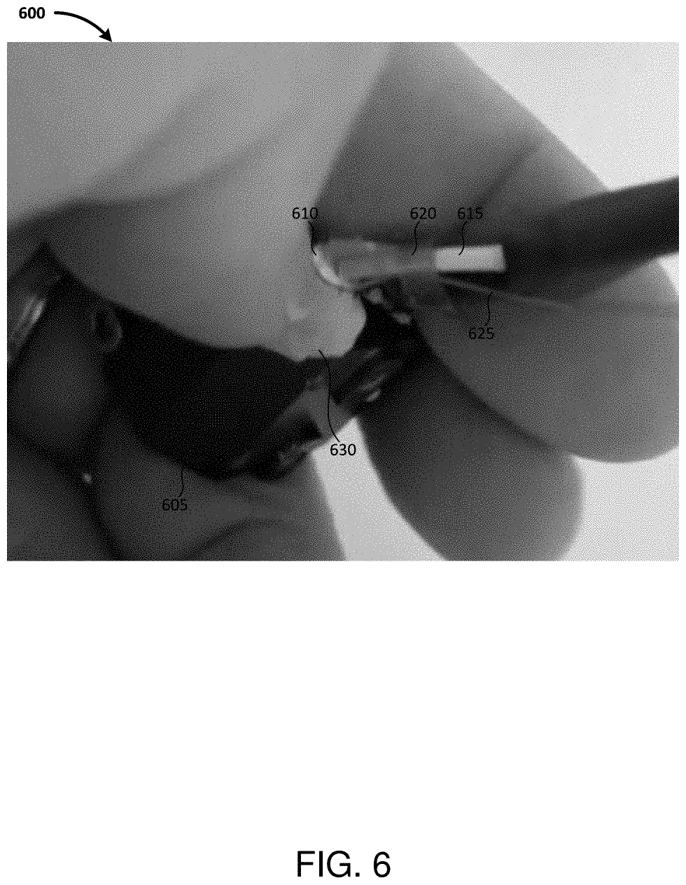

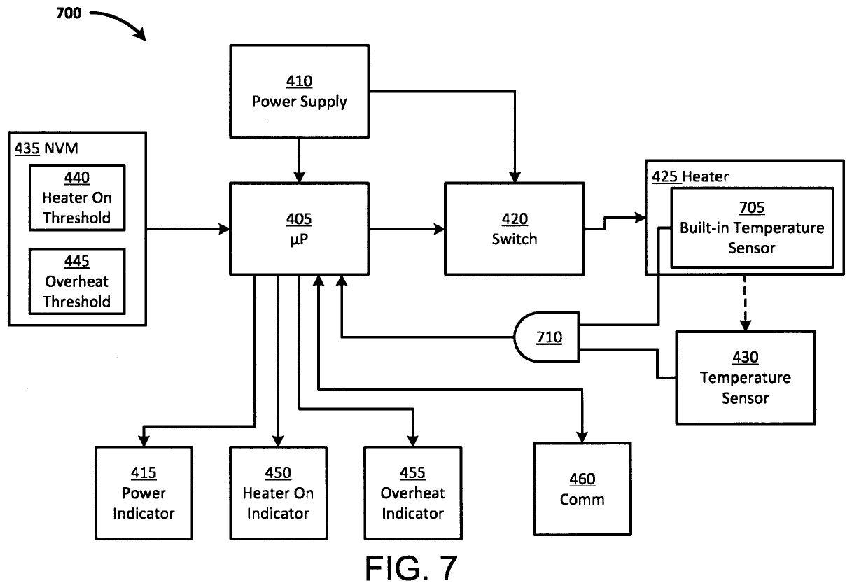

To aid understanding, this document is organized as follows. First, to help introduce discussion of various embodiments, a thermal runaway interlock (TRI) is introduced with reference to FIG. 1. Second, that introduction leads into a description with reference to FIGS. 2-4 of some exemplary embodiments of the TRI. Third, with reference to FIG. 5, an exemplary operation method is described in application to exemplary additive manufacturing machines. Fourth, with reference to FIG. 6, the discussion turns to exemplary embodiments that illustrate an exemplary temperature sensor of a TRI mounted to a hot end. Fifth, and with reference to FIG. 7, this document describes exemplary apparatus and methods useful for reducing erroneous deactivation of the additive manufacturing machines. Finally, the document discusses further embodiments, exemplary applications and aspects relating to thermal runaway protections for additive manufacturing machines.

FIG. 1 depicts an exemplary thermal runaway interlock (TRI) employed in an illustrative use-case scenario. In the depicted scenario 100, an additive manufacturing machine 105 (“3D printer,” such as a fused deposition modeling (FDM) printer) is provided with a hot end 110 (e.g., a thermoplastic filament extrusion head). The hot end 110 includes an extruder body 115. The extruder body 115 is provided with a heater core 120. The heater core 120 and extruder body 115 are provided with a lumen 125 (e.g., for material to pass through and be extruded out, such as in a (semi-)molten state). A temperature sensor 130 (e.g., thermistor, thermocouple, resistance temperature detector (RTD such as PT100), semiconductor-based temperature sensor) is disposed, as depicted, in thermal communication with the heater core 120.

A TRI 135 is provided with a (power) controller 140. The controller 140 receives power 145 from a power source (e.g., from a building electrical power receptacles, power supply). The controller 140 further receives an input from the temperature sensor 130. An indicator module 150 may display a current status of the TRI 135, power status to the heater core 120, temperature state of the heater core 120 as detected by the temperature sensor 130, or some combination thereof. For example, the indicator module may be provided with a power on indicator, hot end active indicator, overheat fault indicator, or some combination thereof. In various embodiments the indicators may include, by way of example and not limitation, visual indicia, audible indicators, haptic feedback, or some combination thereof.

In various embodiments the controller 140 may output power to the heater core 120. The power output to the heater core 120 may, for example, be determined as a function of the power 145 and/or the signal from the temperature sensor 130. In various embodiments the power output to the heater core 120 may, for example, be determined as a function of one or more (predetermined) thresholds. For example, the threshold may include a hot end ‘active’ and/or ‘safe’ threshold, a hot end ‘overheat’ threshold, or some combination thereof.

For example, in some embodiments, the power output to the heater core 120 may, for example, be disconnected in response to a signal from the temperature sensor 130. For example, if a signal from the temperature sensor 130 indicates a temperature exceeding a first (predetermined) temperature threshold, then the controller 140 may disconnect the power 145 from the heater core 120. Accordingly, the TRI 135 may advantageously interlock the power to the heater core 120 based at least on the temperature sensor 130. For example, if a temperature controller fails (e.g., the heater core 120 is separated from another (e.g., built-in) sensor, a power controller fails in an “ON” (power supplied to the heater core 120 mode)), the heater core 120 may be advantageously disabled by the TRI 135. Accordingly, various embodiments may advantageously prevent fires (e.g., during unattended operations), prevent damage to the additive manufacturing machine 105, or some combination thereof. In some implementations, the power controller may include, by way of example and not limitation, a field effect transistor (e.g., FET, MOSFET), a triode (e.g., TRIAC), rectifier (e.g., SCR), relay, and/or integrated circuit (e.g., ASIC).

In some implementations, the temperature sensor 130 may be a cartridge sensor pre-installed in a canister or cartridge of the additive manufacturing machine 105. For example, the pre-installed temperature sensor may advantageously make installation, maintenance, and/or replacement of the TRI 135 easier.

FIG. 2 depicts an exemplary schematic of a TRI. An exemplary TRI 200 is provided with a power reset monitor 205. The power reset monitor 205 is configured to monitor the presence of an input voltage (YIN) (e.g., from a power source). A power supply 210 is connected to the input voltage and configured to generate a control voltage (V_{CC}) Output of the control voltage activates a first indicator L1 (e.g., LED), with current regulated by a resistor R1. The first indicator L1 may, for example, indicate that power is provided to a relay 215. The relay 215 receives power to a coil 216. The coil 216 controls a contactor 217. The contactor 217 controls the main power (V_{IN}) to a hot end 220. Accordingly, the hot end 220 may be operated via the relay 215 operating the contactor 217.

A threshold controls circuit 225 provides first and second inputs to comparator 230 and comparator 235, respectively. As depicted, the first input is a first threshold T1, and second input is a second threshold T2. The thresholds T1 and T2 may be, by way of example and not limitation, predetermined during configuration of the TRI 200, adjusted by a user (e.g., by variable resistors), received from an external module, or some combination thereof. The comparator 230 compares the first threshold T1 to an input signal received from a temperature sensor T configured to monitor the temperature of the hot end 220. If the temperature exceeds the first threshold T1, then the comparator 230 may output a signal through a resistor R1 to a second indicator L2. For example, the indicator L2 (e.g., an LED) may indicate that the hot end 220 has reached a (predetermined) operating temperature.

The comparator 235 compares the second threshold T2 to the input signal received from the temperature sensor T. In the depicted example, the comparator 235 is an open collector output. As depicted, the output is high (pulled high by a resistor R3) to the control node C when the input from the temperature sensor T has not exceeded the second threshold T2. If the temperature exceeds the second threshold T2, then the comparator 235 may pull the control node C low. Accordingly, a base of a PNP transistor Q1 may be pulled low by a resistor R4. Accordingly, current flow through the coil 216 may be interrupted, opening the contactor 217 and thereby deactivating power to the hot end 220.

When the output of the comparator 235 is pulled low, current flow (regulated by a resistor R5) through the transistor Q2 may be induced, thereby activating an indicator L3 (with current regulated by a resistor R6). For example, the indicator L3 may indicate that the hot end 220 has reached and/or exceeded a (predetermined) overheat temperature and has been disabled.

The control node C is further coupled to the power reset monitor 205. The control node C is coupled to an edge detection circuit 238 of the power reset monitor 205 and configured to detect, in the depicted example, a negative edge. Accordingly, when the control node C is pulled low by the comparator 235, the edge detection circuit 238 may generate a signal to a latch 240 (e.g., including a silicon-controlled rectifier (SCR) circuit). The latch 240 may drive a base of an NPN transistor Q3 such that the transistor Q3 pulls the control node C low. For example, even when the hot end 220 cools below the overheat temperature threshold T2, the latch 240 may hold the control node C low, maintaining the hot end 220 in a disabled state and the indicator L3 in an activated state (e.g., corresponding to a thermal runaway event). Accordingly, the hot end 220 may be latched ‘off’ by the latch 240 until the input power source (V_{IN}) is reset. The latch 240 may also, for example, latch the (overheat) indicator L3 on to indicate that an overheat event occurred until the power is reset.

In various embodiments the power reset monitor 205 may operate the latch 240 according to at least one predetermined reset criteria. For example, the power reset monitor 205 may operate the latch 240 to release after V_{IN} has dropped below a first predetermined threshold voltage (e.g., 0V, 500 mV, 5V), dropped below a second predetermined threshold voltage for a predetermined time period (e.g., 5 millisecond, 1 second, 5 minutes), or some combination thereof.

In various embodiments, a testing bypass circuit may be provided which pulls the control node C low. Operation of the testing bypass circuit (e.g., by a push-button, switch) may cause the circuit to enter the same state as if the hot end 220 exceeded the second temperature threshold T2. For example, a user may operate the testing bypass circuit to determine if the latch 240 and power reset monitor 205 are still operational to latch the TRI 200 in a “disabled” mode in which the hot end 220 is deactivated when T2 is exceeded. Operation of the testing bypass circuit may activate the latch 240 such that resetting (e.g., interruption) of the power to the TRI 200 may be required to supply power to the hot end 220.

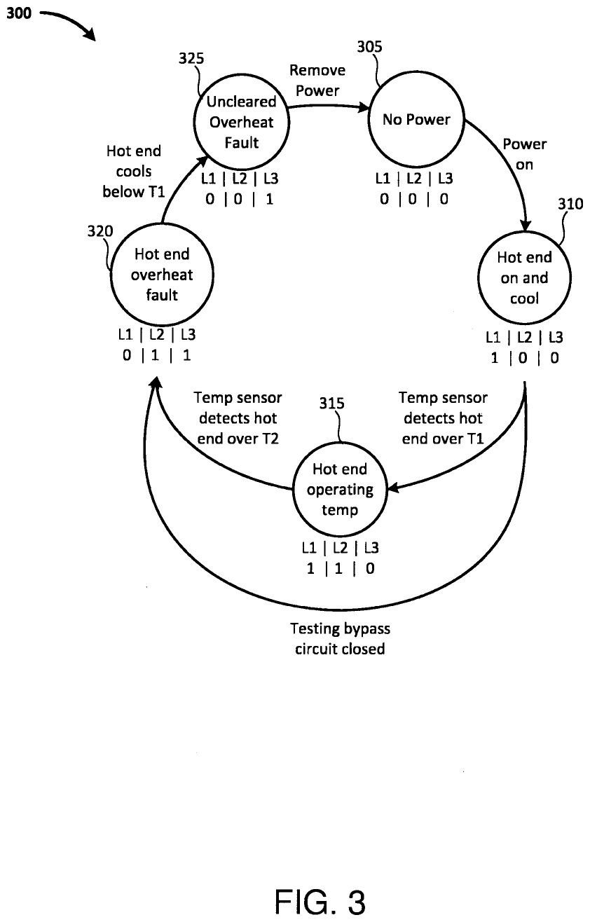

FIG. 3 is an exemplary state diagram of the exemplary TRI of FIG. 2. In the depicted example 300, the TRI 200 is in a first state 305 (no power state), in which all three indicators L1, L2, and L3 are off (indicated by “0” below each reference symbol). Power is turned on (V_{IN} is applied, such as by plugging in the TRI 200 to a power source), and the TRI 200 enters a second state 310. In the second state 310, L1 is activated (indicated by “1” below the corresponding reference symbol), indicating the TRI 200 is in a powered state. Power is supplied to the hot end 220 from the power supply 210 via the relay 215. The hot end 220 is still cool (e.g., below the first temperature threshold T1).

The temperature sensor T except the hot end 220 has exceeded the first temperature threshold T1. Accordingly, the TRI 200 enters a third state 315. In the third state 315, L2 is activated, indicating that the hot end 220 has reached an operating temperature (at/over T1). A fourth state 320 may be reached from either the second state 310 or the third state 315. The fourth state 320 may be reached from the third state 315 by the temperature sensor detecting that a temperature of the hot end 220 has exceeded the second temperature threshold T2. The fourth state 320 may also be reached from the second state 310 or the third state 315 by activation of the testing bypass circuit.

In the fourth state 320, the indicator L3 is on, indicating an overheat condition. L1 is off, indicating no power to the hot end 220. L2 is off as a result of the removal of power. The power may be latched off by the power reset monitor 205 and latch 240, which may latch on the indicator L3. Accordingly, a user may be advantageously advised of the occurrence of an overheat condition even after the temperature of the hot end 220 has dropped below T2.

As the hot end 220 cools below T1, the fifth state 325 is reached. L2 deactivates (indicating the hot end 220 is no longer above T1, e.g., is no longer at an operating temperature). However, L3 remains activated, maintaining the indication that an overheat event has occurred. The TRI 200 reaches the first state 305 again by resetting power to the TRI 200 (e.g., as determined by power reset monitor 205, such as according to predetermined reset parameter(s)). Accordingly, the latching circuit is reset and the hot end 220 may be powered again.

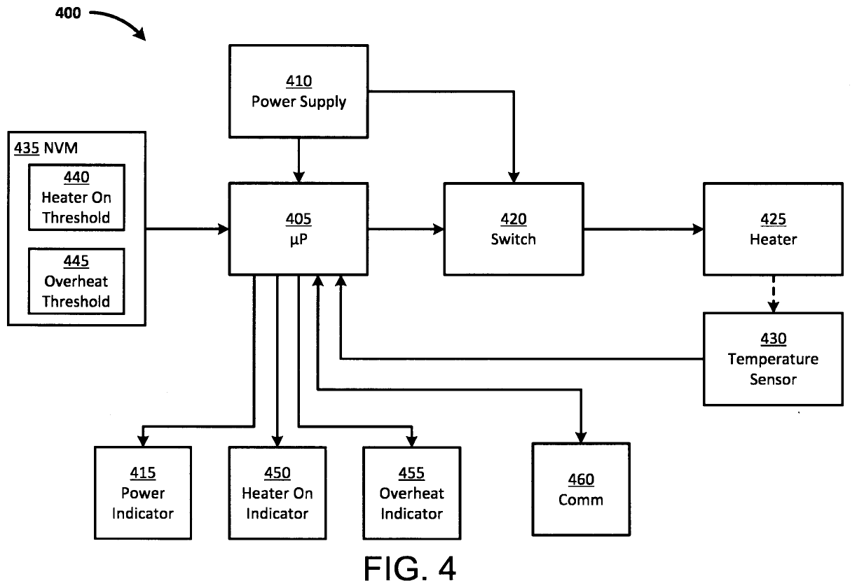

FIG. 4 depicts an exemplary block diagram of a digitally implemented TRI. In the depicted TRI 400, a processor 405, (e.g., microprocessor labeled μP), is in electrical communication with a power supply 410. The processor 405 is in electrical communication with a power indicator 415. The processor 405 may activate the power indicator 415 in response to receiving power from the power supply 410.

The power supply 410 is further in electrical communication with a switch module 420. The switch module 420 is also in electrical communication with the processor 405. For example, the switch module 420 may be a relay (e.g., electromechanical, solid state). The processor 405 may operate the switch module 420 into an “ON” state or an “OFF” state. The switch module is in electrical communication with a heater module 425 (e.g., hot end). The switch module may selectively electrically connect the power supply 410 to the heater module 425 in the “ON” state and may electrically disconnect the power supply 410 to the heater module 425 in the “OFF” state. Accordingly, the heater module 425 may be selectively activated by the processor 405 controlling the state of the switch module 420.

The heater module 425 is in thermal communication (e.g., by proximity, thermal bridge) to a temperature sensor 430. The temperature sensor 430 is in electrical communication with the processor 405. The processor 405 may operate the switch module 420 as a function of the temperature sensor 430.

The processor 405 is further operably coupled to an NVM module 435 (non-volatile memory module). The NVM module 435 includes, in the depicted example, a heater on temperature threshold 440 and an overheat temperature threshold 445. The processor 405 may, for example, be configured (e.g., by running a program of operations stored on the NVM module 435) to operate the switch module 420 into the OFF position in response to the temperature sensor 430 outputting a signal corresponding to a temperature exceeding the overheat temperature threshold 445. The processor 405 may, for example, ‘latch’ the switch module 420 into the OFF position until power is reset (e.g., interrupted, such as by unplugging and/or by a manual switch). Accordingly, the TRI 400 may advantageously enhance safety by preventing re-activation of a (faulty) heater module 425 without user intervention.

In the depicted example, the processor 405 is further connected to a heater on indicator 450 and an overheat indicator 455, each in electrical communication with the processor 405. The processor 405 may, for example, be configured to operate the indicator 450 and the overheat indicator 455 as a function of the temperature threshold 440 and the overheat temperature threshold 445, respectively. For example, the processor 405 may activate the indicator 450 in response to the temperature sensor 430 generating a signal corresponding to the heater module 425 reaching or exceeding a temperature corresponding to the temperature threshold 440. The processor 405 may activate the overheat indicator 455 in response to the temperature sensor 430 generating a signal corresponding to the heater module 425 reaching or exceeding a temperature corresponding to the overheat temperature threshold 445. Accordingly, a user may, for example, advantageously be quickly apprised of the current status of the TRI 400 and/or the heater module 425 by a quick glance at the power indicator 415, the indicator 450, and/or the overheat indicator 455. The processor 405 may, for example, latch the overheat indicator 455 on until the power to the TRI 400 is reset. Accordingly, the TRI 400 may advantageously indicate to a user that an overheat event has occurred even if the heater module 425 has already cooled below the overheat temperature threshold 445.

In the depicted example, a communication module 460 is in operable (e.g., wired, wireless) communication with the processor 405. The communication module 460 may provide communication between the TRI 400 and external devices (e.g., mobile device, cloud server, computer, additive manufacturing machine control unit, 3D print build monitoring system). The communication module 460 may, for example, receive input signals and/or generate signals in response to input from a user, transmit signals in response to output from the processor 405 (e.g., power status, temperature status), or some combination thereof. In some embodiments the communication module 460 may include, by way of example and not limitation, include circuits configured to communicate via ethernet, Bluetooth, Wi-Fi, USB (e.g., USB-A, USB mini, USB micro, USB-C), or some combination thereof.

In various embodiments a self-test input may be provided to the processor 405 (e.g., by a human-machine interface, such as a button, switch, app input). The self-test input may, for example, provide a signal to the processor 405, and/or induce the processor 405 to generate a signal, indicative of a signal from the temperature sensor 430 indicative of overheat. Accordingly, the user may advantageously determine if the thermal interlock functionality of the TRI 400 is still operative (e.g., if the heater module 425 is disabled, if the overheat indicator 455 is activated, if the power must be reset before re-enabling of the heater module 425 and/or deactivation of the overheat indicator 455).

FIG. 5 depicts a flowchart of an exemplary method of operation of a TRI. In the depicted method 500, the method may begin when power is provided to the TRI (e.g., TRI 135, TRI 200, TRI 400). In response to activation of power (e.g., by plugging in the TRI, operating a switch), a POWER ON indicator is activated 505 (e.g., according to the TRI 200, by the processor 405). Input temperature (e.g., of a hot end, such as the hot end 220, the heater module 425) is checked in step 510 (e.g., by processor 405 according to input from temperature sensor 430, by comparator 230 according to input from temperature sensor T). If the current temperature does not exceed 515 a first threshold T1, then the depicted method 500 returns to step 510. If the current temperature does exceed 515 the first threshold T1, then a “HEATER ON” indicator is activated 520.

If the temperature does not exceed 525 a second threshold T2, then the method 500 checks whether a self-test input has been provided 530. If not, then the depicted method 500 returns to step 510. If the temperature does exceed 525 the second threshold T2, or if the self-test input has been provided 530, then power is disabled 535 and a “TRIPPED” indicator (e.g., corresponding to an overheat fault) is activated. Power may be “latched” off in a disabled state. The TRIPPED indicator may be latched ON in an activated state. Accordingly, even if the temperature drops below T2, the power may be held in a disabled state and/or the TRIPPED indicator may be latched in an activated state until the power is reset to the TRI.

In the depicted example, if the power is not reset 540, then a latching state of the power and the TRIPPED indicator is maintained 545. Once the power is reset, the latch is released 550. Accordingly, the power may be re-enabled and/or the TRIPPED indicator may be deactivated.

FIG. 6 depicts an exemplary temperature sensor of a TRI mounted to a hot end. In the depicted scenario 600, an extruder head 605 is provided with a heater cartridge 610 disposed within a cavity of the extruder head 605. Power conduit 615 (e.g., electrical cables/wires/cords) is in electrical communication with the heater cartridge 610. The power conduit 615 is wrapped, as depicted, with a securing element 620 (e.g., heat-resistant tape such as a polyimide film tape). A sensor element (not shown) is electrically coupled to a data conduit 625 (e.g., wire/cable/cord, such as configured to carry an electric signal). The data conduit 625 may, for example, be coupled to a monitoring circuit (e.g., comparator 230, comparator 235, processor 405). The data conduit 625, as depicted, is mechanically coupled to the power conduit 615 by the securing element 620. In some embodiments, the data conduit 625 may, by way of example and not limitation, be a “high quality” wire that can handle repeated bending (e.g., due to movement of the extruder head 605).

As depicted, the sensor is thermally coupled to the heater cartridge 610 (e.g., directly, via the extruder head 605) with thermal cement 630. The thermal cement 630 may, for example, advantageously mechanically couple the sensor to the heater cartridge 610 and/or the extruder head 605. Accordingly, accidental thermal uncoupling of the sensor from the heater cartridge 610 may be advantageously prevented. Bonding of the heater cartridge 610 to the extruder head 605 may, for example, advantageously prevent the heater cartridge 610 from uncoupling from the extruder head 605 and dangling out and potentially contacting unintended material (e.g., causing a fire).

FIG. 7 depicts an exemplary block diagram of a digitally implemented TRI 700 that receives input from more than one temperature sensors. In this example, the TRI 700 receives inputs from the temperature sensor 430 and a built-in temperature sensor 705. In some implementations, the temperature sensor 430 and the built-in temperature sensor 705 both measure a temperature of the heater module 425. As shown, the TRI 700 includes a logic AND gate 710. As described with reference to FIG. 4, the processor 405 may operate the switch module 420 as a function of an output of the logic AND gate 710. In some implementations, the logic AND gate 710 may output a signal corresponding to a temperature exceeding the overheat temperature threshold 445 when both the temperature sensor 430 and the built-in temperature sensor 705 exceed the overheat temperature threshold 445. In various examples, the TRI 700 may advantageously prevent false disconnection of the heater module 425 when either the temperature sensor 430 or the built-in temperature sensor 705 is temporarily disconnected. In some examples, the TRI 700 may also include a timer module. For example, the timer module may include a predetermined time threshold such that the switch circuit is only activated if an overheat signal is maintained for a time longer than the predetermined time threshold. In some examples, the timer module may advantageously prevent unnecessarily disconnecting the heater module 425 and scrap a work product currently under printing (e.g., avoid ‘false alarms’ due to a momentary spike in temperature reading or disruption in signal from only one temperature sensor).

In various implementations, the logic AND gate 710 may be integrated into a circuit board (e.g., a circuit as described with reference to FIG. 2). For example, the TRI 200 may include an electrical circuit implementing the logic AND gate 710 that may include inputs form comparison outputs from two comparators comparing T2 with the temperature sensor 430 and the built-in temperature sensor 705, respectively. The output from the logic AND gate 710 may operate the relay 215. For example, the relay 215 may be tripped when both the temperature sensor 430 and the built-in temperature sensor 705 exceeds the temperature threshold T2.

In some implementations, the built-in temperature sensor 705 may, for example, be an additional temperature sensor (e.g., a second auxiliary temperature sensor). For example, a kit may include the temperature sensor 430 and at least one second temperature sensor. The at least one second temperature sensor may, for example, be configured to be thermally coupled to a heater element (e.g., a hot-end). In some implementations, the at least one second temperature sensor may, for example, be configured to be thermally coupled to a print bed.

In some implementations, the logic AND gate 710 may, for example, be configured as an OR gate. For example, such implementations may be configured to detect an overheat condition if any one temperature sensor or (predetermined) subset of temperature sensors (e.g., ‘redundant’ temperature sensors) exceeds a predetermined temperature threshold. Such implementations may, for example, advantageously be implemented in high-risk environments (e.g., highly flammable materials, occupied areas), to detect an overheat even if one temperature sensor or subset of temperature sensors fails. In some implementations, cascaded logic gates may include, by way of example and not limitation, cascaded AND and/or OR gates (e.g., AND gates configured to change state when all connected inputs such as sensors meet a predetermined criterion, with at least one OR gate configured to change state when any AND gate changes state).

Although various embodiments have been described with reference to the figures, other embodiments are possible. For example, although an exemplary system has been described with reference to the figures, other implementations may be deployed in other industrial, scientific, medical, commercial, and/or residential applications.

In various embodiments a heater module (e.g., e.g., hot end 220, heater module 425) may, for example, further include and/or be controlled by additional circuitry, such as a driver module. For example, an additive manufacturing machine control (e.g., a 3D printer control board(s)), may operate a heater cartridge (e.g., according to manual user input, according to a predetermined program of operations such as, by way of example and not limitation, in the form of a G-code file). A switch module (e.g., relay 215, switch module 420) may, for example, control power supply to the heater, a heater control circuit, or some combination thereof. For example, in some embodiments a TRI (e.g., TRI 200, TRI 400) may operate as an interlock to override operation of the heater (e.g., disabling the heater) in the event of a thermal runaway event, regardless of commands which may be to the contrary from a printer control circuit (e.g., commanding the heater to continue operations). In some embodiments the TRI 200 may, for example, disable the printer control circuit(s). In some embodiments the TRI 200 may, for example, disable power to motion equipment (e.g., stepper motors, servo motors) in addition to the heater, but not disable the printer control circuit(s). In some embodiments the TRI 200 may, for example, generate a signal alerting a control circuit (e.g., a printer control circuit, a monitoring circuit) of a thermal runaway event. The control circuit may, for example, respond by pausing motion and/or thermal operations, enabling an emergency mode, alerting a user to a thermal runaway event (e.g., remotely, locally), or some combination thereof.

In various embodiments a relay may, by way of example and not limitation, be limited to substantially 10 A. A power source may, by way of example and not limitation, be 12V, 24V, 120V (nominal), 220V (nominal). In various embodiments a power controller may, for example, be auto-switching. For example, a power controller may include a voltage regulator which regulates a provided input voltage of a range of acceptable input voltages to a (predetermined) control voltage. The regulated control voltage may, by way of example and not limitation, be 3.3V, 5V, 12V, 24V. In various embodiments a switching power supply may be provided (e.g., to provide V_{CC}, to provide V_{IN}). In various embodiments a transformer coupling may be used to step up or step down input voltage to a control voltage.

In various embodiments, a fuse may be disposed in an electrical path to a hot end/heater cartridge. If the fuse blows (e.g., excessive current draw corresponding to overheating), the fuse may open the circuit such that the hot end is isolated from power.

In various embodiments at least one temperature threshold, for example, may be adjustable. For example, a user may operate a human-machine interface (e.g., a knob, a button, a switch, an input on an app running on a computing device) to set a desired temperature threshold (e.g., operating, overheat). In some embodiments, for example, selectable predetermined temperature thresholds may be provided. For example, a predetermined temperature threshold(s) may be provided for different materials. In some embodiments, by way of example and not limitation, at least one predetermined temperature threshold (e.g., an operating and/or overheat threshold) may be provided for materials including, by way of example and not limitation, polylactic acid (PLA), acrylonitrile butadiene styrene (ABS), polyamides (nylon), polyethylene terephthalate (PET), polyetherimide (Ultem), or some combination thereof. In some embodiments an operating temperature threshold may, by way of example and not limitation, be 200° C., 250° C., 275° C., or therebetween. An overheat temperature threshold may, by way of example and not limitation, be 300° C., 325° C., 350° C., or somewhere therebetween. In some embodiments, for example, an operating temperature threshold may be set just below a melting point of one or more intended materials, a predetermined amount above an ambient temperature, or some combination thereof. Some embodiments may, for example, be provided with an overheat temperature threshold set just below an ignition temperature of intended materials, but above a melting temperature. In various embodiments, an overheat temperature (e.g., T2 as disclosed at least with reference to FIGS. 2-5) may be greater than an operating temperature (e.g., T1 as disclosed at least with reference to FIGS. 2-5).

In various embodiments power may be provided, by way of example and not limitation, via an International Electrotechnical Commission (IEC) plug. A power connector may, for example, be provided with a National Electrical Manufacturers Association (NEMA) plug (e.g., 5-15P), IEC 60320 C18, or some combination thereof.

In various embodiments a first indicator (e.g., L1 as disclosed at least with reference to FIG. 4) may, by way of example and not limitation, include a green light. A second indicator (e.g., L2 as disclosed at least with reference to FIG. 4) may, by way of example and not limitation, include a yellow light. A third indicator (e.g., L3 as disclosed at least with reference to FIG. 4) may, by way of example and not limitation, include a red light.

In some embodiments a heater block may be pre-coupled, for example, to a sensor. The heater block may, for example, be configured as a ‘drop-in’ replacement for existing heater blocks. In some embodiments, the heater block may, by way of example and not limitation, be configured as a 6-6.35 mm diameter round heater cartridge block.

In some embodiments a kit may be provided, for example, which may be suitable for fitting an existing additive manufacturing machine with a TRI. An exemplary kit may include, by way of example and not limitation, a TRI circuit (e.g., as disclosed at least with reference to FIGS. 2-5), connectors (e.g., Phoenix style), a tool (e.g., screwdriver) to operate the connectors, thermal cement (e.g., as disclosed at least with reference to FIG. 6), instructions, or some combination thereof. In some embodiments the kit may be configured to allow a user to install the kit and be “printing within an hour.”

In various embodiments, for example, a TRI may be installed on an additive manufacturing machine by thermally coupling a sensor (e.g., as disclosed at least with reference to FIG. 6) to a heater cartridge of the machine. The TRI may, for example, be operably coupled in series between a power source (e.g., a wall plug) and the additive manufacturing machine.

After installation, a user may test the device. For example, a user may first plug the TRI into a power source. The user may observe whether a power indicator is activated (e.g., indicating power is enabled to the heater cartridge). The user may then operate the additive manufacturing machine such that the temperature of the heater cartridge (e.g., as read by the temperature sensor) reaches a predetermined curing temperature (range) (e.g., greater than a first (operating) temperature threshold). The user may observe whether an operating temperature indicator is activated. The user may, for example, operate the machine such that the heater cartridge maintains the predetermined curing temperature (range) for at least a predetermined minimum curing time.

The user may then operate a SELF-TEST circuit. The user may, for example, observe whether an overheat fault indicator is activated, and if the power indicator is deactivated. The user may, for example, monitor the temperature of the heater cartridge to determine if the overeat fault indicator remains activated, the power indicator remains deactivated, and/or the heater cartridge remains disabled even after the temperature of the heater cartridge falls below the overeat temperature threshold. Accordingly, the user may advantageously determine if the TRI is operational to thermally interlock the heater cartridge. In various embodiments the user may, for example, repeat the self-test procedures on a predetermined recurring basis (e.g., weekly, monthly, quarterly, before each print).

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

Temporary auxiliary energy inputs may be received, for example, from chargeable or single use batteries, which may enable use in portable or remote applications. Some embodiments may operate with other DC voltage sources, such as a 9V (nominal) battery, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device, such as a CRT (cathode ray tube) or LCD (liquid crystal display) monitor for displaying information to the user, a keyboard, and a pointing device, such as a mouse or a trackball by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IoT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the module(s) may involve execution of preprogrammed instructions, software executed by a processor, or some combination thereof. For example, various modules may involve both hardware and software.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A protection circuit comprising:
a power input;
a state controller configured to receive a control voltage output;
a temperature sensor input to the state controller;
a power output operated by the state controller, and configured to selectively provide power to a field effect transistor (FET) operating a heater element; and,
at least one visual indicating element operated by the state controller, wherein:
in response to the power input meeting an operating power criterion and the temperature sensor input being less than a first predetermined temperature threshold, then, the state controller activates the power output and a first predetermined indication of the at least one visual indicating element,
when the power output is in the activated state, in response to the temperature sensor input rising above a second predetermined temperature threshold, then the state controller activates a second predetermined indication of the at least one visual indicating element, wherein the second predetermined temperature threshold is lower than the first predetermined temperature threshold, and,
when the power output is in the activated state, in response to the temperature sensor input rising above the first predetermined temperature threshold for longer than a predetermined time, then the state controller performs thermal runaway protection operations, wherein the thermal runaway protection operations comprise:
(a) activate a third predetermined indication of the at least one visual indicating element, deactivate the power output, and deactivate the first predetermined indication, and,
(b) maintain the second predetermined indication in the activated state until the temperature input falls below the second predetermined temperature threshold.

2. The protection circuit of claim 1, wherein the thermal runaway protection operations further comprise interlocking the state controller from activating the power output until a reset command is received.

3. The protection circuit of claim 1, wherein the state controller operates at least one relay to control the power output.

4. The protection circuit of claim 1, further comprising a power converter coupled to the power input, wherein the power converter is configured to generate the control voltage output as a reduced voltage from the power input.

5. The protection circuit of claim 1, wherein the power input is independently controlled from the power output such that deactivating the power output does not deactivate the power input.

6. The protection circuit of claim 1, further comprising a logic gate configured to generate the temperature input as a function of the inputs from a first temperature sensor and a second temperature sensor.

7. The protection circuit of claim 1, wherein the protection circuit is integrated into an additive manufacturing control system, wherein the power input is an operating voltage of the system, and the power output controls operating power to the FET.

8. A protection circuit comprising:
a power input;
a state controller configured to receive a control voltage output;
a temperature sensor input to the state controller;
a power output operated by the state controller, and configured to selectively provide power to a power controller operating a heater element; and,
at least one visual indicating element operated by the state controller, wherein:
in response to the power input meeting an operating power criterion and the temperature sensor input being less than a first predetermined temperature threshold, then, the state controller activates the power output and a first predetermined indication of the at least one visual indicating element,
when the power output is in the activated state, in response to the temperature sensor input rising above a second predetermined temperature threshold, then the state controller activates a second predetermined indication of the at least one visual indicating element, wherein the second predetermined temperature threshold is lower than the first predetermined temperature threshold, and,
when the power output is in the activated state, in response to the temperature sensor input rising above the first predetermined temperature threshold, then the state controller performs thermal runaway protection operations, wherein the thermal runaway protection operations comprise:
(a) activate a third predetermined indication of the at least one visual indicating element, deactivate the power output, and deactivate the first predetermined indication, and,
(b) maintain the second predetermined indication in the activated state until the temperature input falls below the second predetermined temperature threshold.

9. The protection circuit of claim 8, wherein the power controller comprises a field effect transistor configured to fail in an ON-state providing uncontrolled power to the heating element.

10. The protection circuit of claim 8, wherein the thermal runaway protection operations further comprises interlocking the state controller from activating the power output until a reset command is received.

11. The protection circuit of claim 8, wherein the state controller operates at least one relay to control the power output.

12. The protection circuit of claim 8, wherein the power output is alternative current (AC) power.

13. The protection circuit of claim 8, wherein the power output is direct current (DC) power.

14. The protection circuit of claim 8, further comprising a power converter coupled to the power input, wherein the power converter is configured to generate a control voltage output as a reduced voltage from the power input.

15. The protection circuit of claim 8, wherein the power input is independently controlled from the power output such that, deactivating the power output does not deactivate the power input.

16. The protection circuit of claim 8, wherein at least one of the first predetermined temperature threshold and the second predetermined temperature threshold are user adjustable.

17. The protection circuit of claim 8, further comprising a logic gate configured to generate the temperature input as a function of the inputs from a first temperature sensor and a second temperature sensor.

18. The protection circuit of claim 8, wherein, when the power output is in the activated state, the thermal runaway protection operations are performed in response to the temperature sensor input rising above the first predetermined temperature threshold exceeding a predetermined time.

19. The protection circuit of claim 8, wherein the protection circuit is integrated into an additive manufacturing control system, wherein the power input is an operating voltage of the system, and the power output controls operating power to the power controller.

20. A thermal runaway protection kit comprising:
a thermal runaway protection circuit configured to selectively operate a heater element based on a temperature of the heater element;
at least one temperature sensor operably coupled to the thermal runaway protection circuit;
and,
means for thermally and mechanically coupling the at least one temperature sensor to the heater element,
wherein the thermal runaway circuit further comprises,
a power input;
a temperature sensor input, wherein the temperature sensor input is configured to receive input form the at least one temperature sensor;
a power output configured to selectively provide power to a power controller operating the heater element; and,
at least one visual indicating element, wherein:
in response to the power input meeting an operating power criterion and the temperature sensor input being less than a first predetermined temperature threshold, then, the thermal runaway protection circuit activates the power output and a first predetermined indication of the at least one visual indicating element,
when the power output is activated, in response to the temperature sensor input rising above a second predetermined temperature threshold, then the thermal runaway protection circuit activates a second predetermined indication of the at least one visual indicating element, wherein the second predetermined temperature threshold is lower than the first predetermined temperature threshold, and,
when the power output is activated, in response to the temperature sensor input rising above the first predetermined temperature threshold, then the thermal runaway protection circuit performs thermal runaway protection operations, wherein the thermal runaway protection operations comprise:
(a) activate a third predetermined indication of the at least one visual indicating element, deactivate the power output, and deactivate the first predetermined indication;
(b) maintain the second predetermined indication in the activated state until the temperature input falls below the second predetermined temperature threshold; and,
(c) interlock the thermal runaway circuit from activating the power output until a reset command is received.
